(19) United States
(12) Patent Application Publication
(10) Pub. No.: US 2004/0208688 A1
(43) Pub. Date: Oct. 21, 2004

(54) Articulation sleeve for a clamp

(75) Inventors: Wolfgang Barbett, Rhede (DE); Markus Kramer, Mainhausen (DE)

Correspondence Address: Friedrich Kueffner, Suite 910, 317 Madison Avenue, New York, NY, 10017, US

(73) Assignee: Rasmussen GmbH

(21) Appl. No.: 10/814,928

(22) Filed: Mar. 31, 2004

(30) Foreign Application Priority Data
Apr. 2, 2003 (DE) 103 14 999.6

(51) Int. Cl. F16B 7/08

(52) U.S. Cl. 403/234

(57) ABSTRACT

Articulation sleeves for a clamp having strip ends formed into closed loops are surrounded by the loops. The head of a clamping screw, extending through slots in the loops and through the articulation sleeves is rotatably supported during clamping on one sleeve and a nut screwed onto the screw shaft is supported on a second sleeve and secured against rotation by a special shape of the sleeve. The sleeves have coaxial circular holes provided diametrically opposed one another. The clamping screw passes through the coaxial holes that are identical and whose diameter matches nearly the shaft diameter of the clamping screw. The sleeve is compressed transversely to a longitudinal sleeve axis adjacent to the coaxial holes at least within an area of a polygonal peripheral nut contour and a peripheral screw head contour. The sleeve has a wall area deformed to match the polygonal peripheral nut contour.

### BACKGROUND OF THE INVENTION

1. Field of the Invention

The invention relates to an articulation sleeve for a clamp having closed loops formed at the ends of a clamp strip that surround the articulation sleeves, respectively. At least one clamping screw that extends through slots in the loops as well as through coaxial holes, positioned in the articulation sleeves diametrically relative to the articulation sleeve, is rotatably supported during clamping with its head on one of the articulation sleeves. A nut that is screwed onto the threaded shaft of the clamping screw and has a polygonal peripheral contour is supported on the other articulation sleeve and secured against rotation because of a special shaping of the articulation sleeve. One of the opposed holes is circular and has a diameter that matches nearly the shaft diameter of the clamping screw.

2. Description of the Related Art

In a known articulation sleeve of this kind (DE 3729 372 C2), the nut is secured against rotation in that it is recessed in a quadrangular hole of the articulation sleeve that has a width in the longitudinal direction of the articulation sleeve that is identical to the width of the wrench size of the nut and whose width in the transverse direction of the articulation sleeve is approximately identical to the diameter of the shaft of the clamping screw. The nut is supported in the tightened state on the longitudinal edges of the hole and is positioned with two of its parallel lateral surfaces on the curved transverse edges of the hole. The contact of the nut on the transverse edges prevents a rotation of the nut. The surface area of the quadrangular hole is however significantly larger than the surface area of the cross-section of the screw shaft. This causes a corresponding great weakening of the wall of the articulation sleeve between the opposed holes even though the other one of the two holes is round and its diameter is identical to the shaft diameter of the clamping screw. The articulation sleeve therefore cannot withstand, without suffering significant deformation, very high clamping forces as exerted, in particular, in the case of pipe clamps that are used for connecting pipes.

In another known pipe clamp (DE 299 24 269 U1) having two loops at each end of a clamp strip, articulation parts made of partially curved sheet steel strips are arranged in the loops. In the articulations parts, nuts are non-rotatingly arranged on clamping screws that pass through slots in the loops and openings in the articulation parts. These articulation parts also cannot be loaded with great forces without being deformed.

### SUMMARY OF THE INVENTION

It is an object of the present invention to provide an articulation sleeve of the aforementioned kind that is able to withstand higher clamping forces without suffering significant deformation.

In accordance with the present invention, this is achieved in that the coaxial holes are identical, in that each articulation sleeve is compressed in the transverse direction adjacent to the coaxial holes at least within the polygonal peripheral contour of the nut and a peripheral contour of the screw head, and in that a wall area of the articulation sleeve adjoining the polygonal periphery of the nut, in the mounted state of the articulation sleeve, of the clamping screw, and of the nut, is deformed corresponding to the polygonal peripheral contour of the nut.

With this solution, the surface areas of the coaxial holes are both approximately identical to the cross-sectional surface area of the clamping screw shaft and are correspondingly small. The weakening of the material of the articulation sleeve that is caused by the presence of the coaxial holes between these holes is correspondingly reduced and the strength of the articulation sleeve is increased. Moreover, the deformation of the articulation sleeve in a peripheral area adjacent to the coaxial holes provides an additional reinforcement of the articulation sleeve.

Preferably, it is ensured that the polygonal peripheral contour of the nut is formed by a polygonal section of the nut that has a coaxial cylindrical projection whose outer diameter is smaller than the peripheral diameter of the polygonal nut section; the cylindrical projection is inserted with press fit into the coaxial holes. The nut in this way remains always connected captively to the articulation sleeve. When mounting the articulation sleeve clamp, it is only necessary to insert the clamping screw into the holes of the two articulation sleeves and of the nut(s) and to tighten it.

The projection can have a securing rib that extends externally and tapers conically toward the free end of the projection; the securing rib is arranged with press fit at least in one of the coaxial holes. This securing rib facilitate the introduction of the projection into the coaxial holes and enables an increase of the strength of the connection between the articulation sleeve and the nut in accordance with the oversize of the maximum outer diameter of the securing rib relative to the diameter of the holes and the insertion depth of the projection into the holes.

Preferably, the securing rib has a knurled surface. The knurled surface of the securing rib increases, because of its roughness, the strength of the press fit connection between the articulation sleeve and the nut.

Advantageously, the thread of the nut extends into the projection. This increases the engagement length of the clamping screw in the nut and thus the strength of the threaded connection between the clamping screw and the nut.

The articulation sleeve can be formed of a sheet metal strip and can be connected by welding the abutting longitudinal edges of the sheet metal strip. This configuration enables the manufacture of articulation sleeves by: cutting a large number of sheet metal strips to the desired length from a sheet metal strip that is much longer, wherein a width of the sheet metal strip corresponds to the circumference of the articulation sleeves; stamping the holes into the cut-off sheet metal strips; deforming the peripheral area of the holes; and bending the cut-off sections to articulation sleeves in the same stamping and bending machine. Subsequently, the edges of the cut-off sheet metal strips that abut one another after bending the sheet metal strip to the articulation sleeve shape, are connected by welding. Welding increases the strength of the articulation sleeve.

As an alternative, the articulation sleeve can be formed of a (seamless) pipe section that is not welded. In this connection, a large number of pipe sections can be cut to the desired length from a pipe that is much longer and can be provided in the same machine with holes and can be deformed therein. In this case, the welding step is no longer needed. On the other hand, a long seamless pipe (a pipe that is not welded) is more difficult to manufacture as a starting material and is available only in reduced length in comparison to a starting material in the form of sheet metal strip.

### BRIEF DESCRIPTION OF THE DRAWING

In the drawing:

FIG. 1 shows an axial section of the articulation sleeve with inserted nut;

FIG. 2 shows an unsectioned view of the articulation sleeve according to FIG. 1 rotated by 90° relative to the position of FIG. 1;

FIG. 3 shows an unsectioned view of the articulation sleeve of FIG. 1 rotated by 90° relative to the position of FIG. 2;

FIG. 4 shows an unsectioned view of the articulation sleeve of FIG. 1 rotated by 90° relative to the position of FIG. 3;

FIG. 5 shows an enlarged detail of FIG. 1;

FIG. 6 is a cross-section VI-VI of FIG. 5;

FIG. 7 shows the same axial section of the articulation sleeve as FIG. 1 but without inserted nuts;

FIG. 8 shows an unsectioned view of the articulation sleeve according to FIG. 7 but rotated by 90° relative to FIG. 7;

FIG. 9 shows an unsectioned view of the articulation sleeve according to FIG. 7 but rotated by 90° relative to FIG. 8;

FIG. 10 shows an unsectioned view of the articulation sleeve according to FIG. 7 but rotated by 90° relative to FIG. 9;

FIG. 11 shows an enlarged detail of FIG. 7;

FIG. 12 shows cross-section XII-XII of FIG. 11; and

FIG. 13 shows a side view of one of the nuts of the articulation sleeve according to FIGS. 1 through 6 enlarged relative to the illustration of FIG. 1.

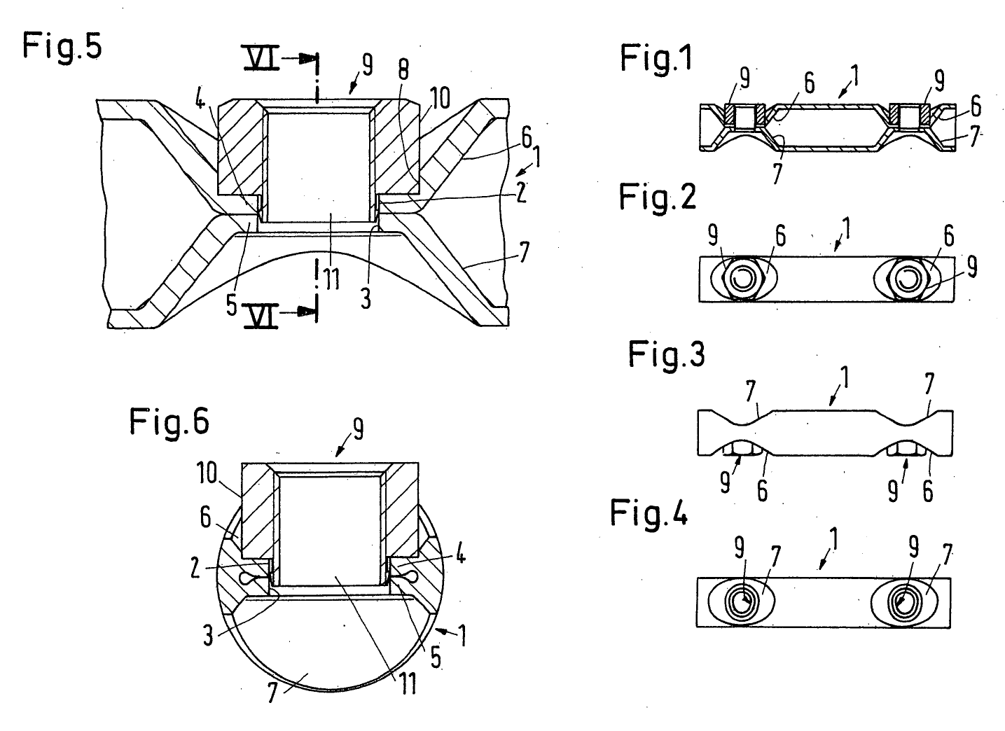

### DESCRIPTION OF THE PREFERRED EMBODIMENTS

Two articulation sleeves that correspond to the illustrated articulation sleeve 1 are inserted into a clamp (not illustrated), for example, a pipe clamp, into the closed loops of the end sections of the clamp strip. Each end section forms in the present case two loops with slots for inserting a clamping screw (not illustrated). The clamping screw has a screw head with a polygon socket and a screw shaft provided with a thread. The illustrated articulation sleeve 1 therefore has two coaxial holes 2, 3 for passing a clamping screw through the articulation sleeve, respectively. The holes 2, 3 are positioned diametrically opposite one another relative to the central longitudinal axis of the articulation sleeve 1. They have the same diameter that is somewhat greater than that of the clamping screw shaft.

The articulation sleeve 1 is compressed within a limited peripheral area of each hole pair 2, 3 so that delimited edge areas 4, 5 of the holes 2, 3 rest against one another at the center of the articulation sleeve 1 and, around the edge areas 4, 5, walls 6, 7 result that extend slantedly, as illustrated, or nearly radially, relative to the edge areas 4, 5. The wall area 8 (see in particular FIGS. 8, 11, and 12) extending about the edge area 4 of each hole has a polygonal contour that matches the polygonal peripheral contour of the section 10 of the nut 9. The nut 9 is therefore inserted with its section 10 so that it matches the contour of the wall area 8 and cannot be rotated. Each nut 9 is inserted with a projection 11 that forms a peripherally extending securing rib 12 into the coaxial holes 2, 3 with press fit. The securing rib 12 (see FIG. 13) tapers conically toward its free end and is knurled on its peripheral surface for increasing friction between the securing rib 12 and the holes 2, 3. The outer diameter of the projection 11, including its securing rib 12, is smaller than the diameter of the outer circumcircle of the polygon section 10 of the nut 9. Each nut 9 is supported therefore by the polygonal section 10 on one of the edge areas 4. Between the polygonal section 10 of the nut 9 and the securing rib 12 there is an annular groove 13 or undercut into which, upon pressing the projection 11 into the coaxial holes 2, 3, the displaced material of the articulation sleeve 1 can penetrate. The nuts 9 are therefore arranged very tightly at least in the holes 2 and are captive within the articulation sleeve 1. They form practically a unit together with the articulation sleeve 1. Moreover, they project with diametrically opposed corners past the circumference of the still cylindrical, undeformed sections of the articulation sleeve 1, as illustrated in FIG. 6. However, in a certain rotational position the articulation sleeve 1 can still be inserted without obstruction into the loop pair formed by the end section of the clamp strip when the inner radius of curvature of the loops is slightly greater than the outer radius of the cylindrical sections of the articulation sleeve 1. After insertion of the articulation sleeve 1 into the loops it can be moved into a rotational position in which the corners of the nut 9 extending past the circumference of the articulation sleeve 1 project into a slot of the loops, respectively, so that the articulation sleeve 1 cannot fall out of the loops before the clamping screws are screwed into the nuts 9.

Into each one of the two nuts 9 one of the two clamping screws can be screwed for tightening the pipe clamp. The inner thread of each nut 9 extends moreover from the section 10 into the projection 11. In this way, the thread of the nut and of the clamping screw engage one another across a greater length than without the projection. The screw connection can therefore be loaded by greater loads.

The deformation of the articulation sleeve 1 in the limited peripheral area of the coaxial holes 2, 3 results in a stiffening of the articulation sleeve in this area that causes a very high load capacity of the articulation sleeve without further deformation, in particular, bending, when a clamp, in particular, a pipe clamp, provided with two such articulation sleeves 1 is tightened or clamped. The nuts 9 contribute also to the reinforcement (stiffening).

In clamps with only one loop having a slot in each end section of the clamp strip, one of the halves of the articulation sleeve 1 extending axially, including one of the nuts 9, is obsolete.

The articulation sleeves 1 inserted into the loops are preferably identical. The threaded shaft of the clamping screw can then be screwed through one of the nuts 9 of both articulation sleeves 1, respectively, wherein the clamping screw head rests against the edge area 5 or the outer surface (end face) of the nut 9 of one articulation sleeve 1 and the threaded shaft of the clamping screw engages the nut 9 of the other (opposed) articulation sleeve 1 of the clamp. When both articulation sleeves of a clamp are provided with nuts 9, the risk that the clamping screw is lost or both clamping screws are lost is also reduced.

It is therefore also possible to provide only one articulation sleeve of a clamp with one or two nuts 9 and to eliminate the nut(s) 9 at the other articulation sleeve 1 serving for supporting the screw head.

The sleeve member of the articulation sleeve 1 can be made of a sheet metal strip and the abutting longitudinal edges of the sheet metal strip can be connected by welding. This configuration enables the manufacture of articulation sleeves by: cutting a large number of sheet metal strips to the desired length from a much longer sheet metal strip whose width corresponds to the circumference of the sheet metal articulation sleeve; stamping holes into the cut-off sheet metal strip; deforming the peripheral area of the holes; and bending the cut-off sheet metal strips to articulation sleeves in the same stamping and bending machine. The edges that abut after bending of the sheet metal articulation sleeves 1 of the cut-off sheet strips are then connected by welding. Welding increases the stiffness or strength of the articulation sleeve.

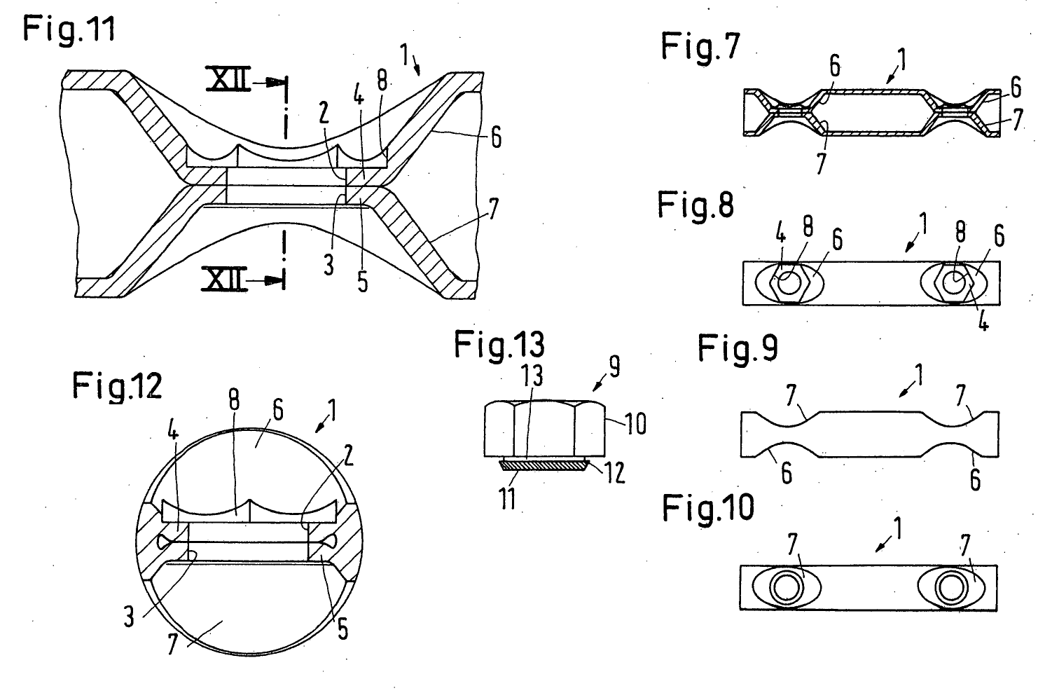

As an alternative, each articulation sleeve 1 can be formed of a pipe section that is not welded and forms the sleeve member. In this connection, a large number of pipe sections (sleeve members) can also be cut to the desired length from a much longer pipe and can be deformed in the same machine to the shape disclosed in FIG. 7 through 11 and 12. In this connection, welding is not needed. However, a long (seamless) pipe that is not welded as starting material is more difficult to produce and available only in reduced length in comparison to sheet metal strips used as starting material.

The articulation sleeve 1 can be used also in connection with clamps whose clamp strip has only one loop at each end wherein each loop is however provided with two slots for passing a clamping screw therethrough.

While specific embodiments of the invention have been shown and described in detail to illustrate the inventive principles, it will be understood that the invention may be embodied otherwise without departing from such principles.

What is claimed is:

1. An articulation sleeve for a clamp, the clamp comprised of a clamp strip having ends formed into closed loops, wherein the loops surround one of the articulation sleeves, respectively, wherein at least one clamping screw, extending through slots in the loops and through the articulation sleeves is rotatably supported during clamping with a screw head on a first one of the articulation sleeves, wherein a nut that is screwed onto a threaded shaft of the clamping screw and has a polygonal peripheral contour is supported on a second one of the articulation sleeves and secured against rotation because of a special shaping of the articulation sleeve; wherein the articulation sleeve comprises:
a sleeve member having coaxial holes provided diametrically opposed in the sleeve member of the articulation sleeve, wherein the at least one clamping screw passes through the coaxial holes;
wherein the opposed coaxial holes are identical and have a circular shape;
wherein a diameter of the circular holes matches nearly a shaft diameter of the at least one clamping screw;
wherein the sleeve member of the articulation sleeve is compressed in a direction transverse to a longitudinal axis of the sleeve member adjacent to the coaxial holes at least within an area of a polygonal peripheral contour of the nut and a peripheral contour of the screw head;
wherein the sleeve member of the articulation sleeve has a wall area, adjoining the polygonal peripheral contour of the nut in the mounted state of the articulation sleeve, of the clamping screw, and of the nut, wherein the wall area is deformed to match the polygonal peripheral contour of the nut.

2. The articulation sleeve according to claim 1, wherein the polygonal peripheral contour of the nut is formed by a polygonal section of the nut having a coaxial cylindrical projection, wherein the projection has an outer diameter that is smaller than a diameter of a circumcircle of the polygonal section and wherein the projection is inserted with press fit into the coaxial holes.

3. The articulation sleeve according to claim 2, wherein the projection has an external securing rib extending peripherally and tapering toward a free end of the projection, wherein the securing rib is arranged at least in one of the coaxial holes with press fit.

4. The articulation sleeve according to claim 3, wherein the securing rib has a knurled surface.

5. The articulation sleeve according to claim 2, wherein the nut has a thread extending into the projection.

6. The articulation sleeve according to claim 1, wherein the sleeve member of the articulation sleeve is formed of a sheet metal strip and wherein abutting longitudinal edges of the sheet metal strip are connected by welding.

7. The articulation sleeve according to claim 1, wherein the sleeve member of the articulation sleeve is a pipe section that is not welded.
